(19) United States
(12) Patent Application Publication
(10) Pub. No.: US 2007/0240060 A1
(43) Pub. Date: Oct. 11, 2007

(54) SYSTEM AND METHOD FOR VIDEO CAPTURE AND ANNOTATION

(75) Inventors: Brian Berenbach, Edison, NJ (US); Bernd Bruegge, Feldafing (DE); Oliver Creighton, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., Princeton, NJ (US)

(21) Appl. No.: 11/625,421

(22) Filed: Jan. 22, 2007

Related U.S. Application Data
(60) Provisional application No. 60/771,498, filed on Feb. 8, 2006.

(51) Int. Cl. G06F 3/01

(52) U.S. Cl. 715/723

(57) ABSTRACT

A video capture tool includes a video camera for capturing a communication, a computer receiving a video feed of the video camera, wherein a logical structure of the communication is previously input to the computer as computer readable code, a display, displaying a graphical user interface for annotating the video feed using the computer, wherein the graphical user interface includes a first control embodied in computer readable code executed by the computer for splitting the video feed into at least two portions according to the logical structure of the communication and a second control embodied in computer readable code executed by the computer for annotating at least one of the two portions, and a database embodied in computer readable code for storing an annotated portion of the video feed.

### CROSS-REFERENCE TO RELATED PATENT APPLICATION

This application claims the benefit of U.S. Provisional Application Ser. No. 60/771,498 (Attorney Docket No. 2006P02593US01), filed Feb. 8, 2006 and entitled “Fly on The Wall Meeting Minutes and Requirements Elicitation Video Tool,” the content of which is herein incorporated by reference in its entirety.

### BACKGROUND OF THE INVENTION

1. Technical Field

The present disclosure relates to knowledge engineering, and more particularly to video capture and annotation for knowledge engineering.

2. Description of Related Art

During meetings, ideas are expressed and discussed, and the outcomes may be action items, decisions, requests for product features and the like. Typically, when the minutes are recorded, the information is incomplete, and follow up meetings are needed. There may be a loss of detail and intent when statements are taken out of context or are not consider in view of other things such as the speakers tone or background.

Problems recording information may be exacerbated, in some cases of a communication chain, e.g., when a stakeholder request becomes a product requirement and is then sent to a development organization, sometimes offshore. Confusion may result, and costs may increase if the delivered products do not meet the intent of the stakeholders.

Research has been done in this area and several projects have dealt with the use of multimedia for capturing meetings for different purposes. The published meeting systems are either developed for general meetings during software projects or for specific kinds of meetings. There has been some work done to integrate speech recognition into those systems.

Several groups have been working on the use of multimedia in requirements engineering. There has been research on the development of new elicitation techniques, and integrating video into existing elicitation techniques like ethnography or scenario based requirements elicitation.

There have also been developed some systems to enhance requirements elicitation meetings. The former one aims on preparing agendas for follow up meetings and the final requirements specification, but a considerable effort is needed to post-process the meeting record. The latter one focuses on the handling of multimedia itself and is in fact the predecessor of the Informedia system developed at CMU.

No known system or method exists for automatically extracting stakeholder statements from the meeting record and populating them into a requirements database. Therefore, a need exists for a video capture system and method for substantially eliminating inconsistencies and ambiguities in the minutes of meetings.

### SUMMARY OF THE INVENTION

According to an embodiment of the present disclosure, a video capture tool includes a video camera for capturing a communication, a computer receiving a video feed of the video camera, wherein a logical structure of the communication is previously input to the computer as computer readable code, a display, displaying a graphical user interface for annotating the video feed using the computer, wherein the graphical user interface includes a first control embodied in computer readable code executed by the computer for splitting the video feed into at least two portions according to the logical structure of the communication and a second control embodied in computer readable code executed by the computer for annotating at least one of the two portions, and a database embodied in computer readable code for storing an annotated portion of the video feed.

According to an embodiment of the present disclosure, a method for video capture includes providing a logical structure of a communication, capturing the communication on video and outputting a corresponding video feed, receiving the video feed at a computer, splitting the video feed into at least two portions according to the logical structure of the communication, linking at least one of the two portions to a knowledge base, and storing the at least one portion of the video feed.

According to an embodiment of the present disclosure, a computer readable medium is provided embodying instructions executable by a processor to perform a method for video capture. The method comprises providing a logical structure of a communication, capturing the communication on video and outputting a corresponding video feed, receiving the video feed at a computer, splitting the video feed into at least two portions according to the logical structure of the communication, linking at least one of the two portions to a knowledge base, and storing the at least one portion of the video feed.

### BRIEF DESCRIPTION OF THE DRAWINGS

Preferred embodiments of the present invention will be described below in more detail, with reference to the accompanying drawings:

FIG. 1 is an illustration of a graphical user interface of a video capture system according to an embodiment of the present disclosure;

FIG. 2 is an illustration of a system according to an embodiment of the present disclosure;

FIG. 3 is flow chart of a video capture method according to an embodiment of the present disclosure;

FIG. 4 is a flow chart of a method for diffusion tensor image visualization according to an embodiment of the present disclosure; and

FIG. 5 is a diagram of a system according to an embodiment of the present disclosure.

### DETAILED DESCRIPTION OF PREFERRED EMBODIMENTS

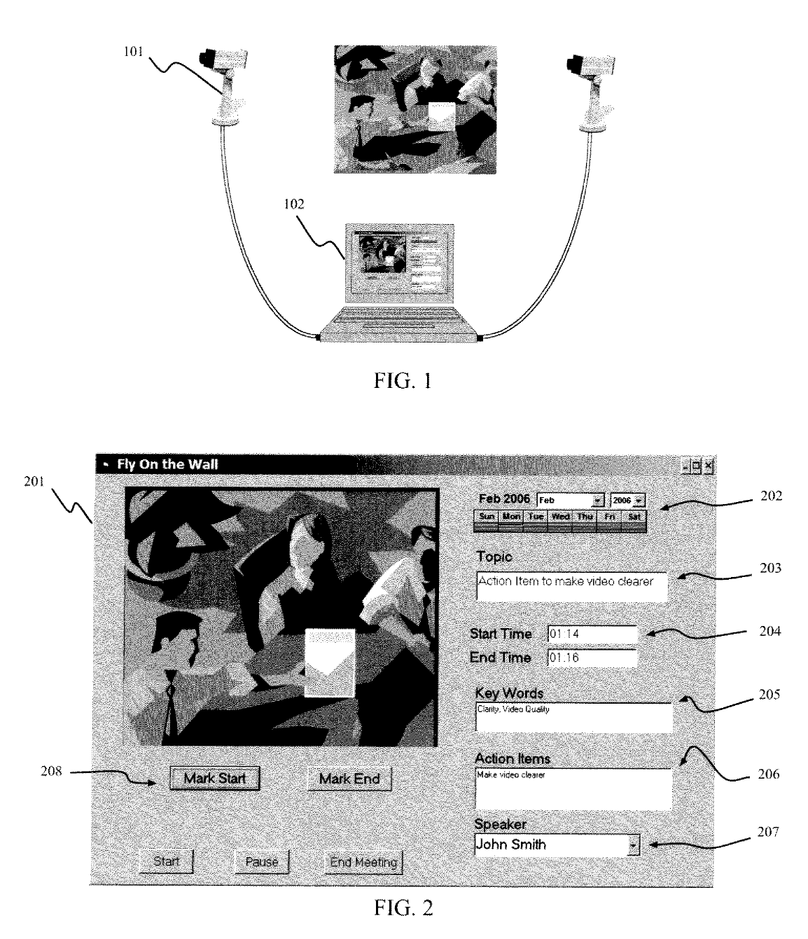

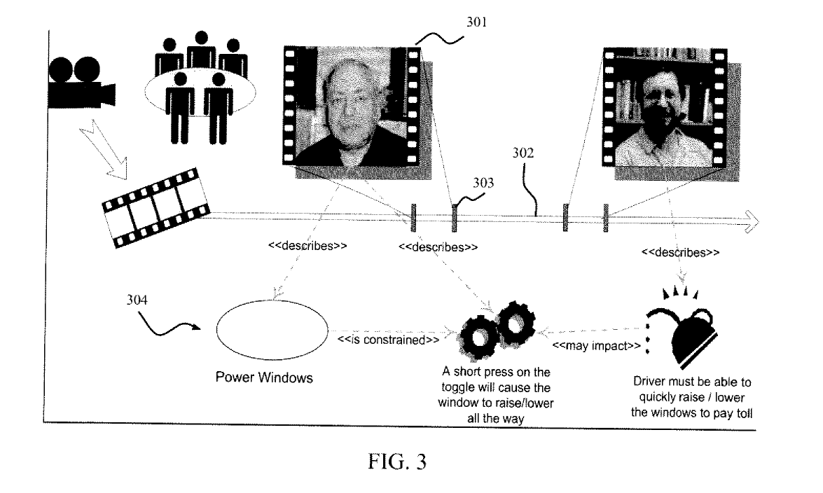

According to an embodiment of the present disclosure and referring to FIG. 1, a tool for capturing video includes one or more video cameras 101 turned on for a meeting and pointed such that they can capture attendees as they speak. Video is fed into a computer 102, for example, a personal computer (PC), personal digital assistant (PDA), or other device. Sections of the video are marked on the fly by (see FIG. 3), for example, a meeting secretary or facilitator, with ancillary information including topic, start/end times of a statement (recorded automatically as the video is marked), the video with sound, keywords associated with statements) and any action items that come out of the statement(s). The output is post processed into a general purpose or specialized database with the annotations.

The fly on the wall recording tool allows for the ability to know the exact specification of stakeholder requests in their own words, full traceability back to requirements, such that a developer in any part of the world can select a requirement in a database, and bring up the original requesters statements), substantially eliminating the ambiguity associated with written and rewritten minutes of meetings transformed into requirements, and a living memory of a product or project history, with all the discussion of original intent, to be used by new staff or management, or to mitigate problems associated with staff turnover on complex or long duration projects.

The present invention will be described further with respect to an exemplary embodiment, wherein a meeting for requirements elicitation is attended by a plurality of stakeholders.

Traditional requirements are defined using notes that have been created during requirements elicitation sessions with one or more stakeholders. These notes are generated by a requirements engineer taking the role of a scribe during the meeting.

The different stakeholders that are involved in these meetings may not share a common language or project knowledge, particularly for meetings occurring in early phases of the project; misunderstandings are therefore commonplace. The notes produced by the scribe may be incomplete, inconsistent or incorrect, for example, due to omissions of statements, misinterpretation of statements, partially notations of a statement or even incorrect notations.

Creating a complete, consistent and correct requirements specification from meeting notes is challenging and it is likely that the produced requirements specification itself is also incomplete, inconsistent and incorrect. Further, as the notes undergo several transcriptions until the final requirements specification is produced, the changes may introduce more defects. In studies including post-mortem defect analysis of products developed using requirements elicitation, up to about 40% of the defects in the system were due to wrongfully, incomplete or omitted requirements.

The proposed framework is designed to improve the requirements elicitation process as well as the traceability of requirements throughout the complete life cycle of a project. To accomplish this task, requirements elicitation sessions are recorded using rich media and stakeholder requests that describe a requirement are extracted and stored in short clips. Those clips are then stored in a database, e.g., a Sysiphus database, where they can be linked to the extracted requirements, to unified modeling language (UML) diagrams, or model elements. The links, e.g., controls in a graphical user interface supported by computer executable code, enable access to related information. For example, an annotated video clip may be linked to a document describing a requirement, wherein a user is presented with the document is also provided a control for retrieving and viewing the video clip.

Sysiphus is a suite of tools for developing and collaborating over software engineering models. In particular, Sysiphus aims at supporting project participants in a geographically distributed environment. Sysiphus provides a simple and integrated system and method for manipulating system models and rationale, while embedding little process specific knowledge. This enables users to adopt different development processes for different projects and to use rationale for a broad range of activities. The tool includes a central repository, which stores all models, rationale, and user information. The repository controls access and concurrency, enabling multiple users to work at the same time on the same models.

In this way the unmodified stakeholder requests become part of the project knowledge and interpretations of requirements can be validated against the original statements, which provide more context than transcripts, e.g., including the way of speaking and body language. This aids in avoiding incomplete and incorrect transcripts as a result of some misunderstanding. In addition developers can easily access this knowledge whenever questions about the origin or the reasoning behind certain requirements occur.

A video capture tool according to an embodiment of the present disclosure may be a standalone software tool in a PDA or other computer that accepts input from one or more video streams, and permits on the fly marking and chunking of the video into discrete segments that are stored in a database.

During post-processing, the annotated video clips are moved into a commercial repository to be part of minute meeting storage and/or a requirements database.

Referring now to real time requirements elicitation: different requirements elicitation techniques exist from which the requirements engineer may choose the appropriate techniques for his purposes. For example, one requirements elicitation technique is called a focus group meeting. In the focus group meeting, a prototype of a product or a slide show of a proposed product is shown to an audience, typically knowledgeable customers. For example, a marketing team might show a software product designed to be used in an operating room to a group of surgeons and operating room nurses, eliciting their opinions about the product and ideas for enhancements or changes. The response of the audience is recorded as minutes of meetings, subject to the inherent errors in the process where notes are taken and then formulated into minutes.

According to an embodiment of the present disclosure, the video capture tool uses a camera and computer to capture the responses. Instead of a single video covering the duration of the meeting, e.g., 6 hours or more, the video is indexed in real time, tagged with information and stored in a requirements database, where the short video clip of an individual speaker can be associated with requirements and retrieved on demand. In this way context and intent are not lost, yet someone wishing to see the source of a requirement need not search through the entire video to find it. Furthermore, all suggestions and comments can be retained and indexed for review as needed, substantially preventing omitted suggestions.

An exemplary requirements elicitation process may involve requirements workshops, which are categorized for our purposes as office based requirements meetings along with joint application development (JAD) and other elicitation techniques that include meetings of stakeholder groups. The video capture tool may be implemented for requirements meetings, but is designed to be extensible to support other kinds of elicitation techniques.

To extract information out of the video record automatically, a structuring is needed which can be exploited for automatic extraction of important statements. Requirements elicitation meetings typically have a structure, provided by an agenda or a presentation that is used to drive the elicitation process. The structure of the meetings allows for automatic extraction of the important statements.

Different approaches to structuring requirements elicitation meetings may be implemented. A basic structuring of a meeting without disturbing the meeting is provided by a designated kind of scribe, who uses an interface 201 of FIG. 2 to set markings when important statements occur and may add additional information in form of annotations to the statements (see FIG. 3). The automatic generation of additional information is possible.

Referring to FIG. 2, an exemplary interface includes facilities for noting dates 202, topics 203, times 204, entering keywords 205 (for example, to triggering automatic notations using a speech recognition engine), action items 206, notating a speaker's name 207, and marking the video 208. One of ordinary skill in the art would appreciate that additional facilities may be added, for example, for camera control, marking confidential matters, identifying speaker's roles (e.g., project manager, software engineer, legal), etc.

As noted, the video capture tool may be augmented by a speech recognition system, a small of keywords and a trained facilitator. Using the grammar of keywords the facilitator is able to impose a basic structuring of the meeting, which is exploitable for automatic extraction of statements.

Referring to requirements tracing: With the integration of the stakeholder statements into the database, they become part of the project knowledge. This way it is possible to iterate the interpretation of those statements and use them for requirements validation purposes or for illustration of the rationale behind the requirements.

In the database itself the stakeholder statements may be linked to the extracted requirements or to UML model elements, and future work may include the realization of a unified model for requirements engineering in the database as FIG. 3 illustrates. FIG. 3 shows an example of a meeting in which two speakers, identified by photographs 301 are recorded by a video feed 302. The video feed is annotated by brackets 303 corresponding to the speaker's comments. The speakers are further associated with notations or summaries 304 of the bracketed comments 303.

Tracing the requirements back to the original stakeholder request allows explorations of questions including, who introduced this requirement, when was this requirement introduced, and why was the requirement introduced.

Extracting a statement from the meeting record may remove the statement out of its context, making it difficult to understand.

A developer, who tracked a requirement back to a statement may lack this understanding and may need more context to fully understand the statement of the stakeholder. For that reason, a link is maintained from the short statement clip to the meeting record, allowing the user access to the context of the statement.

According to an embodiment of the present disclosure, a video capture tool and framework is designed to improve the requirements engineering process by creating correct and complete meeting records and supporting requirements validation by providing the original stakeholder statements against which the requirements can be validated.

Furthermore the framework bridges the gap between the customer and the software developers by allowing the developers access to the original customer statements whenever questions about the rationale or the importance of a requirement occur. In combination with the database it is possible to trace requirements back to the original stakeholder statements.

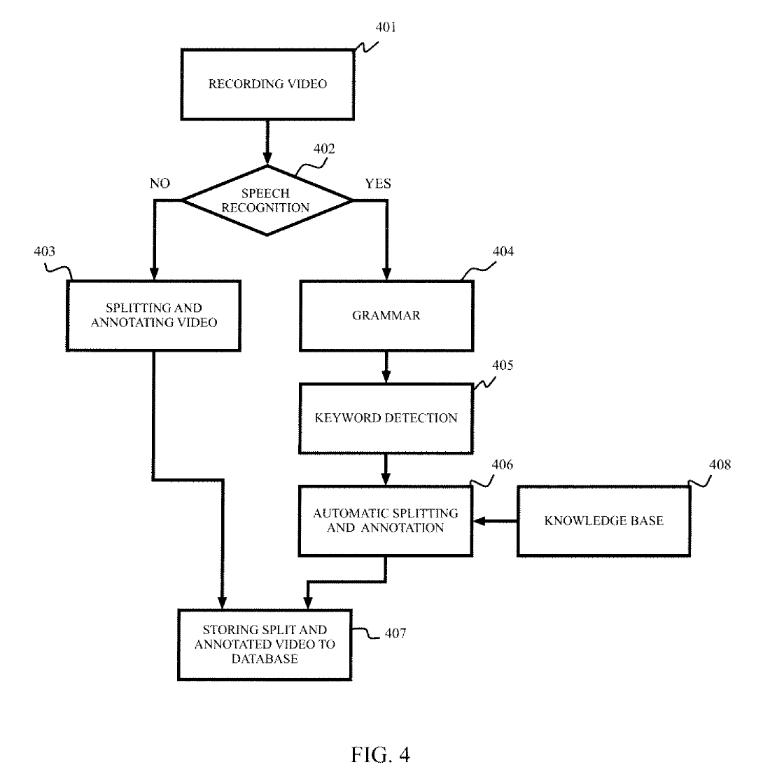

Referring to FIG. 4, video is captured of a target scene 401. If speech recognition 402 is not a component of the tool, the video is manually split and annotated 403. If speech recognition 402 is a component of the tool, a grammar of keywords is retrieved or provided 404 and keyword detection is performed on the captured video 405. Based on detected keywords, the tool automatically splits and annotates video 406. The automatic process may be augmented by manual input. The split and annotated video is stored to a database 407 for later review or data mining.

The splitting and annotation may be performed with a provided knowledge base 408, for example, a transcript of the meeting, the logical structure of the meeting, such as an outline of topics to be covered, or other documents relevant to the subject matter of the meeting. Thus, keywords detected in block 405 may be linked, e.g., by hyperlink, to keywords in the knowledge base. Similarly, the splitting and annotation 403 may be performed in view of the provided knowledge base 408. The knowledge base may be stored together with the split and annotated video.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

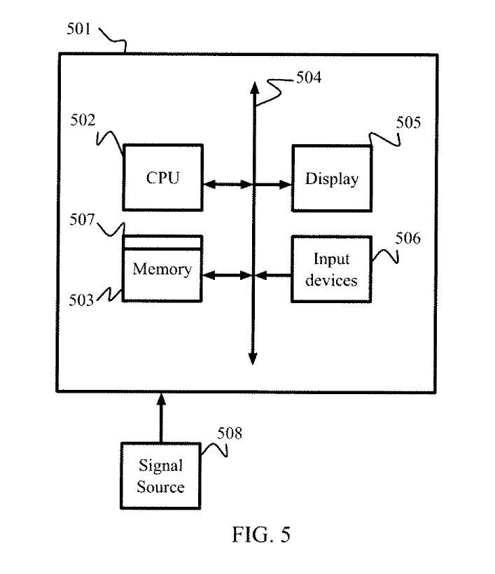

Referring to FIG. 5, according to an embodiment of the present disclosure, a computer system 501 for video capture and annotation for knowledge engineering can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. The present invention can be implemented as a routine 507 that is stored in memory 503 and executed by the CPU 502 to process the signal from the signal source 508. As such, the computer system 501 is a general-purpose computer system that becomes a specific purpose computer system when executing the routine 507 of the present disclosure.

The computer platform 501 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for a system and method for video capture and annotation for knowledge engineering, it is noted that modifications and variations can be made by persons skilled in the art in light of the above teachings. It is therefore to be understood that changes may be made in embodiments of the present disclosure that are within the scope and spirit thereof.

What is claimed is:

1. A video capture tool comprising:
a video camera for capturing a communication;
a computer receiving a video feed of the video camera, wherein a logical structure of the communication is previously input to the computer as computer readable code;
a display, displaying a graphical user interface for annotating the video feed using the computer, wherein the graphical user interface comprises,
a first control embodied in computer readable code executed by the computer for splitting the video feed into at least two portions according to the logical structure of the communication, and
a second control embodied in computer readable code executed by the computer for linking at least one of the two portions to a knowledge base; and
a database embodied in computer readable code for storing the at least one portion of the video feed.

2. The video capture tool of claim 1, further comprising a third control embodied in computer readable code executed by the computer for annotating the at least one portion of video.

3. The video capture tool of claim 1, wherein the knowledge base includes information corresponding to the communication.

4. The video capture tool of claim 1, wherein the knowledge base is a textual record of the communication.

5. The video capture tool of claim 1, wherein the knowledge base is stored in the database.

6. The video capture tool of claim 1, wherein the second control creates a link displayed on the graphical user interface for retrieving the at least one portion of the video.

7. A method for video capture comprising:
providing a logical structure of a communication;
capturing the communication on video and outputting a corresponding video feed;
receiving the video feed at a computer;
splitting the video feed into at least two portions according to the logical structure of the communication;
linking at least one of the two portions to a knowledge base; and
storing the at least one portion of the video feed.

8. The method for video capture of claim 7, further comprising annotating the at least one portion of video.

9. The method for video capture of claim 7, wherein the knowledge base includes information corresponding to the communication.

10. The method for video capture of claim 7, further comprising providing the knowledge base as a textual record of the communication, wherein the linking is a hyperlink embedded in the textual record.

11. The method for video capture of claim 7, further comprising storing the knowledge base in the database.

12. The method for video capture of claim 7, further comprising creating a link displayed on a graphical user interface for retrieving the at least one portion of the video.

13. A computer readable medium embodying instructions executable by a processor to perform a method for video capture, the method comprising:
providing a logical structure of a communication;
capturing the communication on video and outputting a corresponding video feed;
receiving the video feed at a computer;
splitting the video feed into at least two portions according to the logical structure of the communication;
linking at least one of the two portions to a knowledge base; and
storing the at least one portion of the video feed.

14. The method for video capture of claim 13, further comprising annotating the at least one portion of video.

15. The method for video capture of claim 13, wherein the knowledge base includes information corresponding to the communication.

16. The method for video capture of claim 13, further comprising providing the knowledge base as a textual record of the communication, wherein the linking is a hyperlink embedded in the textual record.

17. The method for video capture of claim 13, further comprising storing the knowledge base in the database.

18. The method for video capture of claim 13, further comprising creating a link displayed on a graphical user interface for retrieving the at least one portion of the video.
